(19) United States
(12) Patent Application Publication
(10) Pub. No.: US 2011/0249855 A1
(43) Pub. Date: Oct. 13, 2011

(54) Earphone

(75) Inventors: Shinji Tamura, Kanagawa-Ken (JP); Kazunori Ishizaka, Tokyo-To (JP); Makoto Gondo, Kanagawa-Ken (JP)

(73) Assignee: Victor Company of Japan, Ltd. a corporation of Japan, Yokohama-Shi (JP)

(21) Appl. No.: 13/065,863

(22) Filed: Apr. 1, 2011

(30) Foreign Application Priority Data
Apr. 7, 2010 (JP) 2010-088908

(51) Int. Cl. H04R 1/10

(52) U.S. Cl. 381/380

(57) ABSTRACT

An earphone has a main body, a first tube portion that protrudes from the main body in a first direction, a speaker unit provided at a protruding top of the first tube portion, and a second tube portion that protrudes from the main body in a second direction that is different from the first direction. The second tube portion communicates with the first tube portion through the main body. The speaker unit is provided with a space at one side thereof. The space is formed in the first and second tube portions and extends from the protruding top of the first tube portion to a protruding top of the second tube portion through the main body.

### CROSS-REFERENCE TO RELATED APPLICATIONS

This application is based on and claims the benefit of priority from the prior Japanese Patent Application No. 2010-088908 filed on Apr. 7, 2010, the entire contents of which are incorporated herein by reference.

### BACKGROUND OF THE INVENTION

The present invention relates to an earphone. Specifically, this invention relates to an earplug type (referred to as a canal type, generally) earphone.

A canal-type earphone is equipped with a main body, a tube portion that protrudes from the main body, and a speaker unit provided at the top of the tube portion. The earphone is fit in the auricle of a user's ear in such a way that the top of the tube portion is inserted into the ear channel of the user's ear, with an earpiece attached to the top.

A known earphone is disclosed in Japanese Un-Examined Patent Publication No. 2010-16787, referred to as a document 1, hereinafter. The known earphone is equipped with a main body, a tube portion that protrudes from the main body, and a speaker unit attached to the top of the tube portion.

The known earphone is provided with an empty space (a back cavity) at the rear side of the speaker unit, that is formed by the rear surface of the speaker unit and the inner surface of the tube portion. An end of the empty space is located at the rear side of the speaker unit whereas an opposing end of the empty space is roughly located at a position at which the tube portion is coupled to the main body.

In the known earphone, the speaker unit is not installed in the main body but attached to the top of the tube portion. Thus, the shape of the main body can be determined irrespective of the shape and size of the speaker unit. The main body of the known earphone is formed into a compact and slender shape so that the earphone external appearance is compact and elegant without tightness when attached to a user's ear.

The back cavity of an earphone usually requires a certain volume with respect the size of a speaker unit. As the volume of the back cavity becomes larger, the sound quality of the earphone is more easily adjusted when the sound quality is finally determined in the design process, except for the back cavity having an extremely large volume.

The sound quality of an earphone is adjusted with sound check of several sample earphones produced with different cross sections of a passage in which a back cavity and a space communicate with each other and with different materials of a filter that covers the opening of the passage.

A larger volume of the back cavity provides clearer difference in sound quality of the sample earphones, thus allowing easier adjustments to the sound quality.

Moreover, a larger volume of the back cavity gives a richer low tone to output sounds, thus allowing a wider range of sound quality adjustments.

The known earphone disclosed in the document 1 has a cylindrical tube portion and a speaker unit having a roughly same outer diameter as the tube portion. The tube portion requires a small outer diameter so that it can be inserted into the ear channel of a user's ear.

The known earphone thus has a limit for the back cavity to have a larger volume by enlarging the outer diameter of the tube portion.

Therefore, there is a demand for the back cavity to have a larger volume while the tube portion is insertable to the ear channel of a user's ear.

### SUMMARY OF THE INVENTION

A purpose of the present invention is to provide an earphone equipped with a tube portion and a speaker unit provide at the top of the tube portion, the earphone being attached to a user's ear, with the tube portion and an earpiece attached to the tube portion being inserted into the ear channel, having a back cavity of a large volume that allows easy sound quality adjustments in a wide range.

The present invention provides an earphone comprising: a main body; a first tube portion that protrudes from the main body in a first direction; a speaker unit provided at a protruding top of the first tube portion; and a second tube portion that protrudes from the main body in a second direction that is different from the first direction, the second tube portion communicating with the first tube portion through the main body, wherein the speaker unit is provided with a space at one side thereof, the space being formed in the first and second tube portions and extending from the protruding top of the first tube portion to a protruding top of the second tube portion through the main body.

### BRIEF DESCRIPTION OF DRAWINGS

FIG. 1 an external perspective view of an embodiment of an earphone according to the present invention;

FIG. 2 is a plan view of the earphone attached to a user's left ear and viewed from an upward position;

FIG. 3 is a front view of the earphone attached to the left ear and viewed from a forward position;

FIG. 4 is a sectional view of the earphone taken on line S1-S1 in FIG. 3;

FIG. 5 is a sectional view of the earphone taken on line S2-S2 in FIG. 2; and

FIG. 6 an external perspective view of a modification to the embodiment of the earphone according to the present invention.

### DETAILED DESCRIPTION OF PREFERRED EMBODIMENT

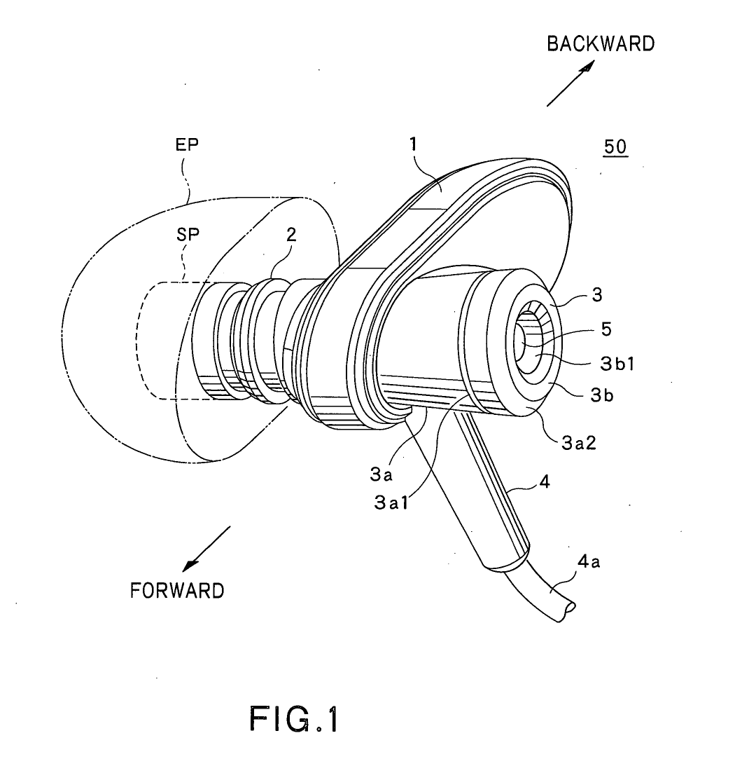

A preferred embodiment according to the present invention will be described with reference to FIGS. 1 to 5.

In FIGS. 1 to 5, a speaker unit SP and an earpiece EP are indicated by a long dashed dotted line and a long dashed double-dotted line, respectively.

FIG. 1 is an external perspective view of an earphone 50, an embodiment of the present invention. FIG. 1 is a perspective view of the earphone 50 attached to a user's left ear (not shown) and viewed from a forward (the user's face side) and diagonally above position.

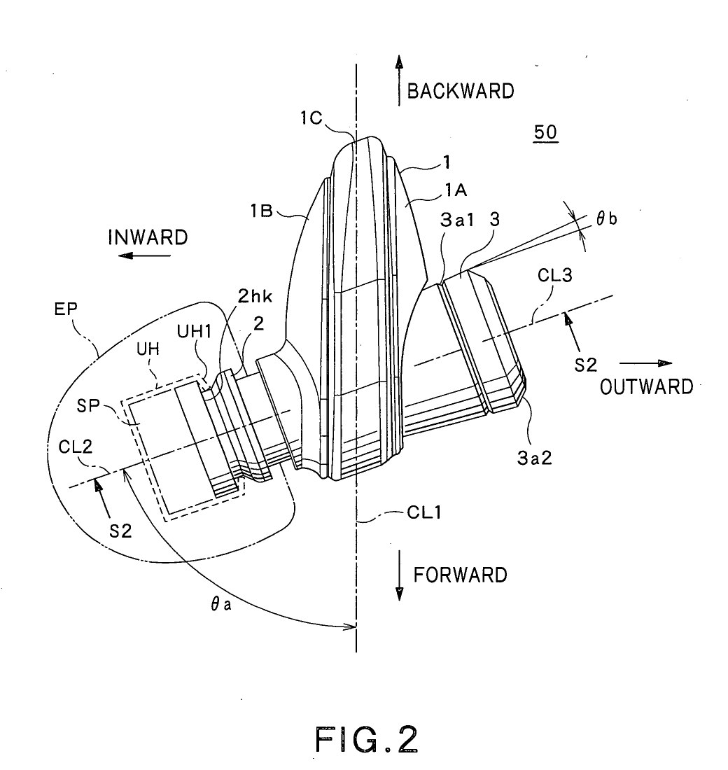

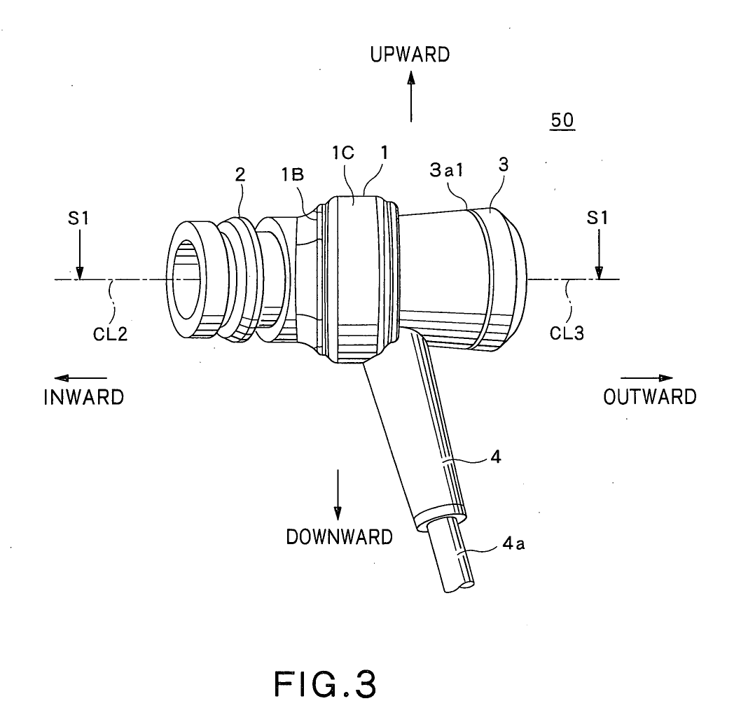

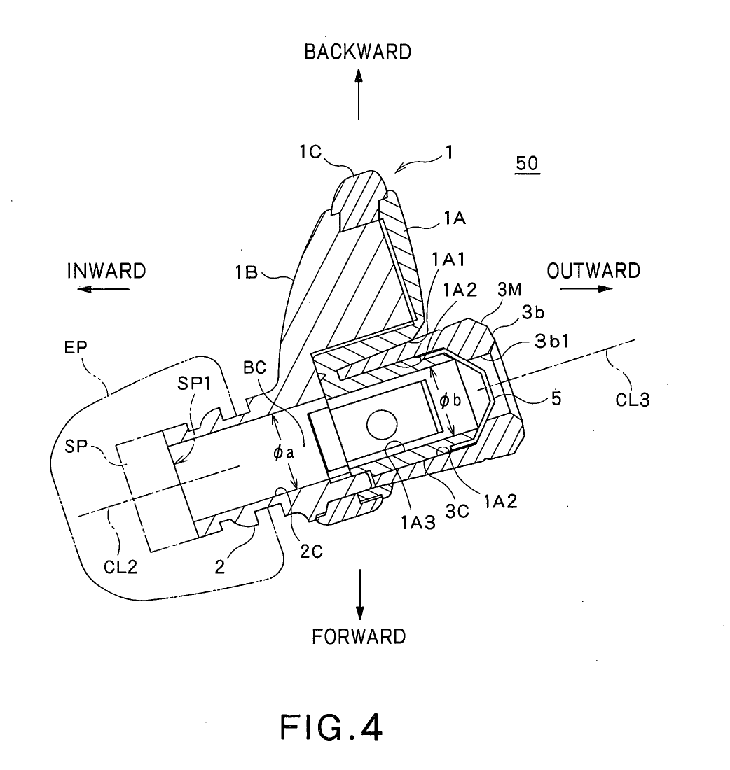

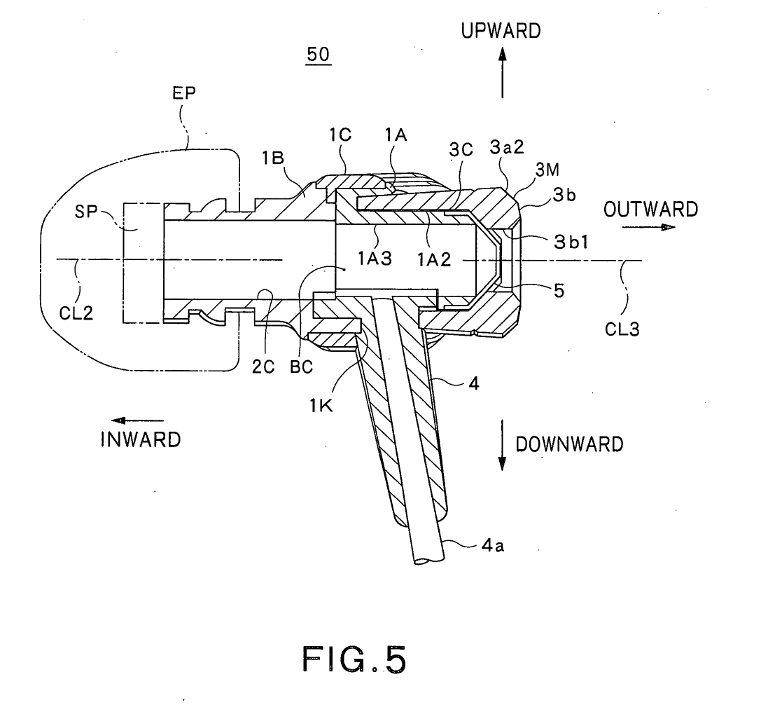

FIGS. 2 and 3 are a plan and a front view of the earphone 50 attached to the left ear and viewed from an upward and a forward position, respectively. FIGS. 4 and 5 are sectional views of the earphone 50 taken on line S1-S1 in FIG. 3 and line S2-S2 in FIG. 2, respectively.

The signs “FORWARD”, “BACKWARD”, “INWARD”, “OUTWARD”, “UPWARD”, and “DOWNWARD” shown in the drawings indicate the directions with respect to the earphone 50 attached to the left ear.

An earphone of the present invention to be attached to a user's right ear has the shape of plane symmetry to the earphone 50 for the left ear. Thus, the earphone 50 for the left ear will only be explained in the following description.

As shown in FIG. 1, the earphone 50 is equipped with a main body 1, a cylindrical tube portion 2 that protrudes from the main body 1 in a diagonally forward and inward direction, a protruding tube portion 3 that protrudes from the main body 1 in a diagonally backward and outward direction, and a cord bushing 4 extending downwardly.

The main body 1 is the portion of the earphone 50 to be fit inside the auricle, with the backward end of the main body 1 being contact with the inner wall of the concha auricle and the forward end of the main body 1 being contact with the inner section of the tragus.

A speaker unit SP (indicated by a long dashed dotted line in FIGS. 1 to 5) is attached to the top of the tube portion 2 in the same way as disclosed in the document 1.

As shown in FIG. 2, the speaker unit SP is installed in a cup-like unit holder UH indicated by a broken line. A top UH1 of the unit holder UH is caulked into a groove 2hk of the tube portion 2 so that the speaker unit SP is attached to the top of the tube portion 2. The speaker unit SP may be adhered to the top of the tube portion 2 by an adhesive, without the unit holder UH.

An earpiece EP (indicated by a long dashed double-dotted line in FIGS. 1 and 2) is detachably attached to the tube portion 2.

A cord 4a is running from the speaker unit SP and extending outside through the cord bushing 4, as shown in FIGS. 1, 3, and 5. The cord 4a is not shown in FIGS. 2 and 4 for clarity.

As shown in FIG. 1, the main body 1 has a long shape in the forward and backward directions with arc-like ends on both sides.

As shown in FIG. 2, the tube portion 2 protrudes inwardly from the main body 1 having an axis line CL1 extending in the forward and backward directions, with an axis line CL2 having an angle θa smaller than 90 degrees with respect to the axis line CL1 when viewed from an upward position. The angle θa is for example 70 degrees, which is determined in relation to the angle of the ear canal to the side area of a user's head.

The protruding tube portion 3 protrudes outwardly from the main body 1, with an axis line CL3 that agrees with the axis line CL2. The protruding tube portion 3 is formed as a portion of a cone that becomes wider with an angle θb, for example 5. 85 degrees, with respect to the axis line CL3. The protruding tube portion 3 has a circumferential groove 3a1 on a circumferential surface 3a (FIG. 1) and a chamfered edge 3a2 at the top section, formed by C-chamfering.

Moreover, as shown in FIG. 1, the protruding tube portion 3 is provided with an opening 3b1 on a top surface 3b. Fit in the opening 3b1 is a mesh 5 exposed to the outside.

The structure of the earphone 50 is described more in detail.

As shown in FIG. 4, the main body 1 includes an outer case 1A provided outwardly and an inner case 1B provided inwardly when the earphone 50 is attached to the left ear. The outer and inner cases 1A and 1B are combined with each other. Moreover, the main body 1 has an annular middle case 1C provided to cover the outer surfaces of the outer and inner cases 1A and 1B engaged with each other. The outer and inner cases 1A and 1B are made of resin. The middle case 1C is made of rubber or elastomer. The tube portion 2 is formed inside the inner case 1B.

As shown in FIG. 5, a hole 1k is provided at the lower section of the main body 1, for the cord bushing 4 to be fit thereinto.

As shown in FIG. 4, the outer case 1A is provided with a roughly annular concave section 1A1 having the axis line CL3 as the center line. Fit into the concave section 1A1 is an ornament 3M that acts as the protruding tube portion 3 (FIG. 3). Moreover, the outer case 1A is provided with a convex section 1A2 having the axis line CL3 as the center line, that protrudes from the concave section 1A1. The convex section 1A2 is fit into the ornament 3M. The convex section 1A2 is provided with a through hole 1A3 having an inner diameter φb.

The protruding tube portion 3 is formed as part of the ornament 3M. Thus, all of the circumferential groove 3a1, the chamfered edge 3a2 and the opening 3b1 are formed on the ornament 3M.

As shown in FIG. 5, the ornament 3M is provided with a through hole 3c that communicates with the opening 3b1. Installed in the ornament 3M is the mesh 5 that covers the opening 3b1 and through hole 3c. The mesh 5 is formed having a reverse chevron shape at the cross section. The mesh 5 acts as a filter with openings of a given size for air to pass through. The mesh 5 may be a metal mesh or a mold resin with openings of a given size for air to pass through.

As shown in FIGS. 4 and 5, the tube portion 2 is provided with a through hole 2c having an inner diameter φa. The through hole 2c of the tube portion 2 and the through hole 1A3 of the convex section 1A2 are concentrically arranged so that they communicate with each other.

The inner end of the through hole 2c is covered by a rear face SP1 of the speaker unit SP. The outer end of the through hole 1A3 is exposed to the outside through the mesh 5 that acts as a filter.

Accordingly, the through holes 2c and 1A3 communicating with each other provide the speaker unit SP with a back cavity BC between the inner and outer ends of the through holes 2c and 1A3, respectively. The back cavity BC encompasses the whole of the through holes 2c and 1A3.

The mesh 5 that is the outer end of the back cavity BC is located outside the main body 1, which gives the back cavity BC a larger capacity than the back cavity of the known earphone, with a specific thickness added to the thickness of the main body 1.

Therefore, the earphone 50 of the embodiment having the back cavity BC with a large capacity allows easy sound adjustments in determining the sound quality.

The earphone 50 is provided with the protruding tube portion 3 that protrudes outwardly from the main body 1. In detail, the protruding tube portion 3 protrudes outwardly from the auricle of a user's left ear when attached to the ear.

The earphone 50 can be easily attached to and taken away from the ear by pinching the protruding tube portion 3 with fingers. As explained with reference to FIG. 2, the protruding tube portion 3 is formed as a portion of a cone that becomes wider with the angle θb. Thus, the protruding tube portion 3 can be pinched firmly with fingers. The protruding tube portion 3 can be pinched more firmly with fingers when the circumferential groove 3a1 of the tube portion 3 is hooked on the fingers. The circumferential groove 3a1 is also provided to accent the appearance of the earphone 50.

It is further understood by those skilled in the art that the foregoing description is a preferred embodiment of the disclosed device and that various changes and modifications may be made in the invention without departing from the spirit and scope thereof.

For example, the inner diameter φa of the through hole 2c and the inner diameter φb of the through hole 1A3 may be or may not be equal to each other. The back pressure of a diaphragm (not shown) of the speaker unit SP decreases when the inner diameter φa is smaller than the inner diameter φb, compared to when the former is larger than the latter. The decrease in the diaphragm's back pressure allows the intrinsic characteristics of the speaker unit SP to be more reflected on reproduced sounds. This results in that original sound is distinguished more easily in sound quality adjustments.

The axis line CL2 of the tube portion 2 and the axis line CL3 of the protruding tube portion 3 may or may not agree with each other, or they may be or may not be parallel with each other.

The through holes 2c and 1A3 may or may not have a cylindrical inner surface, or they may have another shape of curved inner surface, such as conical inner surface. Moreover, the through holes 2c and 1A3 may have continuous cylindrical inner surfaces of different diameters or a combination of different shapes of inner surfaces.

The protruding tube portion 3 may be or may not be cylindrical, or it may be polygonal or another shape, at the cross section. It is further preferable that the protruding tube portion 3 has a more expanded outer shape as being more apart from the main body 1. Nevertheless, the protruding tube portion 3 may not have an expanded outer shape on the whole of outer surface. In detail, the protruding tube portion 3 may have an expanded section on the outer surface, the expanded section being more apart from the axis line CL3 so as to be expanded as being more apart from the main body 1, at least on the portion to be pinched with fingers for easier pinching.

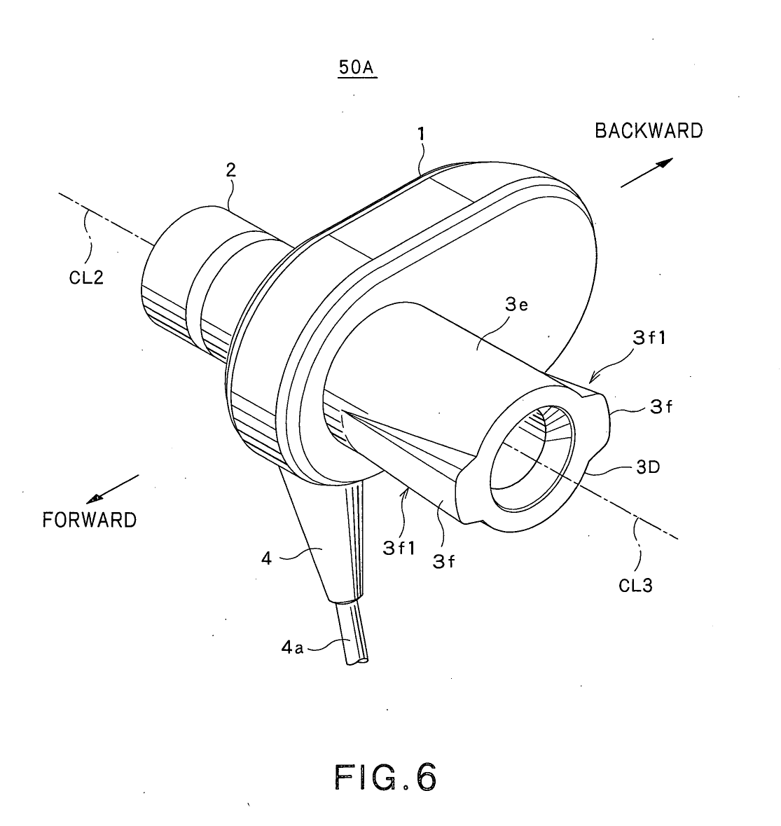

Shown in FIG. 6 is an earphone 50A that is a modification to the earphone 50 of the embodiment.

The earphone 50A is provided with a protruding tube portion 30 having a cylindrical surface portion 3e and expanded portions 3f with outer surfaces 3f1. The expanded portions 3f are more apart from the axis line CL3 so as to be expanded as being more apart from the main body 1. The outer surfaces 3f1 are provided as facing each other with respect to the axis line CL3.

As disclosed above in detail, the present invention provides an earphone equipped with a tube portion and a speaker unit provided at the top of the tube portion, the earphone being attached to a user's ear, with the tube portion and an earpiece attached to the tube portion being inserted into the ear channel, having a back cavity of a large volume that allows easy sound quality adjustments in a wide range.

What is claimed is:

1. An earphone comprising:
a main body;
a first tube portion that protrudes from the main body in a first direction;
a speaker unit provided at a protruding top of the first tube portion; and
a second tube portion that protrudes from the main body in a second direction that is different from the first direction, the second tube portion communicating with the first tube portion through the main body,
wherein the speaker unit is provided with a space at one side thereof, the space being formed in the first and second tube portions and extending from the protruding top of the first tube portion to a protruding top of the second tube portion through the main body.

2. The earphone according to claim 1 wherein the first tube portion and the second tube portion are concentrically arranged.

3. The earphone according to claim 1 wherein the second tube portion has at least one expanded outer section that is more apart from an axis line of the second tube portion so as to be expanded as is more apart from the main body.
